(19) United States
(12) Patent Application Publication
(10) Pub. No.: US 2019/0163035 A1
(43) Pub. Date: May 30, 2019

(54) SYSTEM FOR BALANCING CENTER OF GRAVITY OF A ZOOM LENS

(71) Applicant: SZ DJI TECHNOLOGY CO., LTD., Shenzhen (CN)

(72) Inventor: Hideaki MITA, Shenzhen (CN)

(21) Appl. No.: 16/244,524

(22) Filed: Jan. 10, 2019

Related U.S. Application Data
(63) Continuation of application No. PCT/CN2016/089803, filed on Jul. 12, 2016.

(51) Int. Cl. G03B 15/00; B64D 47/08; B64C 39/02; G03B 17/56

(52) U.S. Cl. CPC G03B 15/006; B64D 47/08; B64C 2201/127; G03B 17/561; B64C 2201/027; B64C 39/024

(57) ABSTRACT

A method for balancing an imaging device includes determining a center of gravity of the imaging device and moving a supporting position of the imaging device based upon the determined center of gravity.

### CROSS-REFERENCE TO RELATED APPLICATION

This application is a continuation of International Application No. PCT/CN2016/089803, filed on Jul. 12, 2016, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The disclosed embodiments relate generally to imaging systems and more particularly, but not exclusively, to support systems and methods for balancing imaging devices.

### BACKGROUND

Aerial imaging has gained popularity in recent years. In a typical aerial imaging system, an imaging device is coupled with an aerial vehicle via a gimbal. The imaging device can include a zoom lens (or a lens unit) for capturing images of scenes in various distances.

The zoom lens normally consists of a plurality of lens groups. The lens groups move when the zoom lens zooms in on (or zooms out from) an object. The movement among the lens groups results in relative position changes among the lens groups and can cause a shift of a center of gravity of the lens groups and thus of the imaging device. The shift of the center of gravity of the imaging device can be an issue for the gimbal because the center of gravity shifts away from a supporting position of the gimbal. The shift of the center of gravity of the imaging device can cause uncontrolled movements of the gimbal, e.g., a pitch of the gimbal during use.

Currently-available approaches for balancing the center of gravity of the imaging device require at least one additional balance weight and at least one dedicated motor for operating the balance weight. Therefore, the currently-available approaches add burden for the gimbal, introduce extra complexity for the imaging system, and increase power consumption.

In view of the foregoing reasons, there is a need for an improved support system and method for balancing the center of gravity of the imaging device.

### SUMMARY

In accordance with a first aspect disclosed herein, there is set forth a method for balancing an imaging device, comprising:

determining a center of gravity of the imaging device; and

moving a supporting position of the imaging device based upon the determined center of gravity.

In an exemplary embodiment of the disclosed methods, moving comprises moving the supporting position to compensate for a change in the center of gravity.

In another exemplary embodiment of the disclosed methods, moving the supporting position comprises aligning the supporting position with the center of gravity.

In another exemplary embodiment of the disclosed methods, determining the center of gravity comprises retrieving center of gravity data from a data source associated with the imaging device.

In another exemplary embodiment of the disclosed methods, retrieving the center of gravity data comprises acquiring the center of gravity data from a lookup table of the data source.

In another exemplary embodiment of the disclosed methods, acquiring the center of gravity data comprises retrieving the center of gravity data from the lookup table based upon an operation command.

In another exemplary embodiment of the disclosed methods, retrieving the center of gravity data comprises searching the lookup table based upon a focal length and a focus position.

In another exemplary embodiment of the disclosed methods, moving the supporting position comprises changing the supporting position according to the retrieved center of gravity data.

In another exemplary embodiment of the disclosed methods, changing the supporting position comprises shifting the supporting position along an optical axis of the imaging device.

Exemplary embodiments of the disclosed methods further comprise determining whether a load applied by the imaging device is within a tolerance range.

In another exemplary embodiment of the disclosed methods, determining whether a load applied by the imaging device is within a tolerance range comprises comparing the load applied by the imaging device with a predetermined load threshold.

In another exemplary embodiment of the disclosed methods, comparing the load comprises detecting the load with a measurement device.

In another exemplary embodiment of the disclosed methods, comparing the load comprises determining the load based upon the center of gravity and a mass of the imaging device.

In another exemplary embodiment of the disclosed methods, determining the load comprises calculating the load according to a focal length and/or a focus position of the imaging device.

In another exemplary embodiment of the disclosed methods, moving the supporting position comprises moving the supporting position when the load is determined to be outside of the tolerance range.

Exemplary embodiments of the disclosed methods further comprise determining an adjustability of the supporting position.

In another exemplary embodiment of the disclosed methods, determining the adjustability comprises ascertaining a restriction of a supporting mechanism associated with the imaging device.

Exemplary embodiments of the disclosed methods further comprise determining a desired movable position of the supporting position.

In another exemplary embodiment of the disclosed methods, determining the desired movable position comprises acquiring the desired movable position based upon a commanded attitude and/or the predetermined load threshold.

In another exemplary embodiment of the disclosed methods, acquiring the desired movable position comprises:

equating the desired movable position to a maximum allowable supporting position when the load is greater than the predetermined load threshold; and

equating the desired movable position to the center of gravity when the load is less than or equal to the predetermined load threshold.

In another exemplary embodiment of the disclosed methods, equating the desired movable position to the maximum allowable position comprises determining the maximum allowable position at which the load of the imaging device is equal to the predetermined load threshold.

In another exemplary embodiment of the disclosed methods, moving the supporting position comprises shifting the supporting position to the desired movable position when the desired movable position is different from a current position of the supporting position and maintaining the supporting position when the desired movable position is equal to the current position.

In another exemplary embodiment of the disclosed methods, shifting the supporting position comprises operating a supporting mechanism of the imaging device to change the supporting position.

In another exemplary embodiment of the disclosed methods, operating the supporting mechanism comprises activating a gimbal associated with the imaging device.

In accordance with another aspect disclosed herein, there is set forth an imaging system for balancing an imaging device, comprising:

one or more processers, individually or collectively, operate to determine a center of gravity of the imaging device; and

a supporting mechanism of the imaging device with a supporting position being configured to move based upon the determined center of gravity.

In an exemplary embodiment of the disclosed imaging systems, the supporting mechanism is configured to move the supporting position to compensate a change in center of gravity of the imaging device.

In another exemplary embodiment of the disclosed imaging systems, the supporting position is configured to align the supporting position with the center of gravity.

Exemplary embodiments of the disclosed imaging systems further comprise a data source associated with the one or more processors for storing center of gravity data.

In another exemplary embodiment of the disclosed imaging systems, the data source comprises a lookup table for retrieving the center of gravity data by the one or more processors.

In another exemplary embodiment of the disclosed imaging systems, the one or more processors are configured to retrieve the center of gravity data from the lookup table based upon an operation command.

In another exemplary embodiment of the disclosed imaging systems, the operation command comprises at least one of a focal length and a focus position.

In another exemplary embodiment of the disclosed imaging systems, the one or more processors are configured to change the supporting position according to the retrieved center of gravity data.

In another exemplary embodiment of the disclosed imaging systems, the supporting position is shifted along an optical axis of the imaging device.

In another exemplary embodiment of the disclosed imaging systems, the one or more processors are configured to activate the supporting mechanism to shift the supporting position.

In another exemplary embodiment of the disclosed imaging systems, the one or more processors are configured to determine whether a load applied by the imaging device is within a tolerance range.

In another exemplary embodiment of the disclosed imaging systems, the tolerance range is defined by a predetermined load threshold.

In another exemplary embodiment of the disclosed imaging systems, the one or more processors are configured to determine the load based upon the center of gravity and a mass of the imaging device.

In another exemplary embodiment of the disclosed imaging systems, the one or more processors are configured to determine the load according to a focal length and/or a focus position of the imaging device.

In another exemplary embodiment of the disclosed imaging systems, the one or more processors are configured to move the supporting position when the load is determined to be outside of the tolerance range.

In another exemplary embodiment of the disclosed imaging systems, the one or more processors are configured to determine an adjustability of the supporting position.

In another exemplary embodiment of the disclosed imaging systems, the adjustability is determined according to a restriction of the supporting mechanism.

In another exemplary embodiment of the disclosed imaging systems, the one or more processors are configured to determine a desired movable position of the supporting position.

In another exemplary embodiment of the disclosed imaging systems, the desired movable position is determined based upon a commanded attitude and the predetermined load threshold.

In another exemplary embodiment of the disclosed imaging systems, the one or more processors are configured to equate the desired movable position to a maximum allowable supporting position when the load is greater than the predetermined load threshold and equate the desired movable position to the center of gravity when the load is less than or equal to the predetermined load threshold.

In another exemplary embodiment of the disclosed imaging systems, the maximum allowable position is a position at which the load of the imaging device is equal to the predetermined load threshold.

In another exemplary embodiment of the disclosed imaging systems, the one or more processors are configured to shift the supporting position to the desired movable position when the desired movable position is different from a current position of the supporting position and maintain the supporting position when the desired movable position is equal to the current position.

In another exemplary embodiment of the disclosed imaging systems, the supporting mechanism is a gimbal associated with the imaging device and an aerial vehicle for providing the supporting position of the imaging device.

In accordance with another aspect disclosed herein, there is set forth a method for controlling a supporting position of an imaging device, comprising:

moving the supporting position; and

balancing a center of gravity of the imaging device via the moving.

In an exemplary embodiment of the disclosed methods, moving the supporting position comprises controlling a movement of the supporting position via one or more controllers.

In another exemplary embodiment of the disclosed methods, moving the supporting position comprises shifting the supporting position to compensate for a change in the center of gravity based upon the controlling.

In another exemplary embodiment of the disclosed methods, moving the supporting position comprises determining the center of gravity of the imaging device.

In another exemplary embodiment of the disclosed methods, determining the center of gravity comprises retrieving center of gravity data from a data source associated with the one or more controllers.

In another exemplary embodiment of the disclosed methods, retrieving the center of gravity data comprises acquiring the center of gravity data from a lookup table of the data source.

In another exemplary embodiment of the disclosed methods, acquiring the center of gravity data comprises retrieving the center of gravity data from the lookup table based upon an operation command.

In another exemplary embodiment of the disclosed methods, retrieving the center of gravity data comprises searching the lookup table based upon a focal length and a focus position.

In another exemplary embodiment of the disclosed methods, moving the supporting position comprises changing the supporting position according to the retrieved center of gravity data.

In another exemplary embodiment of the disclosed methods, changing the supporting position comprises activating a supporting mechanism being associated with the imaging device.

Exemplary embodiments of the disclosed methods further comprise determining whether a load applied by the imaging device is within a tolerance range.

In another exemplary embodiment of the disclosed methods, determining whether a load applied by the imaging device is within a tolerance range comprises comparing the load applied by the imaging device with a predetermined load threshold.

In another exemplary embodiment of the disclosed methods, comparing the load comprises determining the load according to a focal length and/or a focus position of the imaging device.

In another exemplary embodiment of the disclosed methods, moving the supporting position comprises moving the supporting position when the load is determined to be outside of the tolerance range.

Exemplary embodiments of the disclosed methods further comprise determining a desired movable position of the supporting position.

In another exemplary embodiment of the disclosed methods, determining the desired movable position comprises acquiring the desired movable position based upon a commanded attitude and/or the predetermined load threshold.

In another exemplary embodiment of the disclosed methods, acquiring the desired movable position comprises:

equating the desired movable position to a maximum allowable supporting position when the load is greater than the predetermined load threshold; and

equating the desired movable position to the center of gravity when the load is less than or equal to the predetermined load threshold.

In another exemplary embodiment of the disclosed methods, equating the desired movable position to the maximum allowable position comprises determining the maximum allowable position at which the load of the imaging device is equal to the predetermined load threshold.

In another exemplary embodiment of the disclosed methods, moving the supporting position comprises shifting the supporting position to the desired movable position when the desired movable position is different from a current position of the supporting position and maintaining the supporting position when the desired movable position is same as the current position.

In another exemplary embodiment of the disclosed methods, activating the supporting mechanism comprises activating a device associated with a gimbal.

In accordance with another aspect disclosed herein, there is set forth an unmanned aerial vehicle (“UAV”), comprising:

a fuselage;

an imaging device; and

a gimbal for coupling the fuselage and the imaging device with a supporting position being configured to move to compensate for a change in a center of gravity of the imaging device.

Exemplary embodiments of the disclosed UAVs further comprise one or more processers, individually or collectively, operate to determine the center of gravity of the imaging device.

In an exemplary embodiment of the disclosed UAVs, the supporting position is configured to align with the center of gravity.

Exemplary embodiments of the disclosed UAVs further comprise a data source associated with the one or more processors for storing center of gravity data.

In another exemplary embodiment of the disclosed UAVs, the data source comprises a lookup table for retrieving the stored center of gravity data by the one or more processors.

In another exemplary embodiment of the disclosed UAVs, the one or more processors are configured to retrieve the center of gravity data from the lookup table based upon an operation command.

In another exemplary embodiment of the disclosed UAVs, the operation command comprises at least one of a focal length and a focus position.

In another exemplary embodiment of the disclosed UAVs, the one or more processors are configured to change the supporting position according to the retrieved center of gravity data.

In another exemplary embodiment of the disclosed UAVs, the one or more processors are configured to activate the gimbal to shift the supporting position along an optical axis of the imaging device.

In another exemplary embodiment of the disclosed UAVs, the one or more processors are configured to determine whether a load applied by the imaging device is within a tolerance range.

In another exemplary embodiment of the disclosed UAVs, the tolerance range is defined by a predetermined load threshold.

In another exemplary embodiment of the disclosed UAVs, the one or more processors are configured to determine the load based upon the center of gravity and a mass of the imaging device.

In another exemplary embodiment of the disclosed UAVs, the one or more processors are configured to determine the load according a focal length and/or a focus position of the imaging device.

In another exemplary embodiment of the disclosed UAVs, the one or more processors are configured to move the supporting position when the load is determined to be outside of the tolerance range.

In another exemplary embodiment of the disclosed UAVs, the one or more processors are configured to determine a desired movable position of the supporting position.

In another exemplary embodiment of the disclosed UAVs, the desired movable position is determined based upon a commanded attitude and the predetermined load threshold.

In another exemplary embodiment of the disclosed UAVs, the one or more processors are configured to equate the desired movable position to a maximum allowable supporting position when the load is greater than the predetermined load threshold and equate the desired movable position to the center of gravity when the load is less than or equal to the predetermined load threshold.

In another exemplary embodiment of the disclosed UAVs, the maximum allowable position is a position at which the load of the imaging device is equal to the predetermined load threshold.

In another exemplary embodiment of the disclosed UAVs, the one or more processors are configured to shift the supporting position to the desired movable position when the desired movable position is different from a current position of the supporting position and maintain the supporting position when the desired movable position is same as the current position.

In accordance with another aspect disclosed herein, there is set forth an imaging apparatus for balancing an imaging device, comprising:

one or more processers, individually or collectively, operate to determine a center of gravity of the imaging device; and

a supporting mechanism of the imaging device with a supporting position being configured to move based upon the determined center of gravity.

In an exemplary embodiment of the disclosed imaging apparatuses, the supporting mechanism is configured to move the supporting position to compensate for a change in the center of gravity of the imaging device.

In another exemplary embodiment of the disclosed imaging apparatuses, the supporting position is configured to align the supporting position with the center of gravity.

Exemplary embodiments of the disclosed imaging apparatuses further comprise a data source associated with the one or more processors for storing center of gravity data.

In another exemplary embodiment of the disclosed imaging apparatuses, the data source comprises a lookup table for retrieving the center of gravity data by the one or more processors.

In another exemplary embodiment of the disclosed imaging apparatuses, the one or more processors are configured to retrieve the center of gravity data from the lookup table based upon an operation command.

In another exemplary embodiment of the disclosed imaging apparatuses, the operation command comprises at least one of a focal length and a focus position.

In another exemplary embodiment of the disclosed imaging apparatuses, the one or more processors are configured to change the supporting position according to the retrieved center of gravity data.

In another exemplary embodiment of the disclosed imaging apparatuses, the supporting position is shifted along an optical axis of the imaging device.

In another exemplary embodiment of the disclosed imaging apparatuses, the one or more processors are configured to activate the supporting mechanism to shift the supporting position.

In another exemplary embodiment of the disclosed imaging apparatuses, the one or more processors are configured to determine whether a load applied by the imaging device is within a tolerance range.

In another exemplary embodiment of the disclosed imaging apparatuses, the tolerance range is defined by a predetermined load threshold.

In another exemplary embodiment of the disclosed imaging apparatuses, the one or more processors are configured to determine the load based upon the center of gravity and a mass of the imaging device.

In another exemplary embodiment of the disclosed imaging apparatuses, the one or more processors are configured to determine the load according to a focal length and/or a focus position of the imaging device.

In another exemplary embodiment of the disclosed imaging apparatuses, the one or more processors are configured to move the supporting position when the load is determined to be outside of the tolerance range.

In another exemplary embodiment of the disclosed imaging apparatuses, the one or more processors are configured to determine an adjustability of the supporting position.

In another exemplary embodiment of the disclosed imaging apparatuses, the adjustability is determined according to a restriction of the supporting mechanism.

In another exemplary embodiment of the disclosed imaging apparatuses, the one or more processors are configured to determine a desired movable position of the supporting position.

In another exemplary embodiment of the disclosed imaging apparatuses, the desired movable position is determined based upon a commanded attitude and the predetermined load threshold.

In another exemplary embodiment of the disclosed imaging apparatuses, the one or more processors are configured to equate the desired movable position to a maximum allowable supporting position when the load is greater than the predetermined load threshold and equate the desired movable position to the center of gravity when the load is less than or equal to the predetermined load threshold.

In another exemplary embodiment of the disclosed imaging apparatuses, the maximum allowable position is a position at which the load of the imaging device is equal to the predetermined load threshold.

In another exemplary embodiment of the disclosed imaging apparatuses, the one or more processors are configured to shift the desired movable position to the desired movable position when the desired movable position is different from a current position of the desired movable position and maintain the supporting position when the desired movable position is same as the current position.

In another exemplary embodiment of the disclosed imaging apparatuses, the supporting mechanism is a gimbal associated with the imaging device and the aerial vehicle for providing the supporting position of the imaging device.

### BRIEF DESCRIPTION OF THE DRAWINGS

FIG. 1 is an exemplary schematic diagram illustrating an embodiment of an aerial imaging system, wherein an imaging device is coupled with an aerial vehicle.

FIG. 2 is an exemplary flowchart illustrating an embodiment of a method for balancing a center of gravity of the imaging device of FIG. 1.

FIG. 3 is an exemplary block diagram illustrating an alternative embodiment of the method of FIG. 2, wherein the center of gravity of the imaging device is determined.

FIG. 4 is another exemplary block diagram illustrating another alternative embodiment of the method of FIG. 2, wherein a supporting position of the imaging device is moved based upon the center of gravity.

FIG. 5 is an exemplary detail flowchart illustrating still another alternative embodiment of the method of FIG. 2, wherein the supporting position of the imaging device is adjusted to align with the center of gravity of the imaging device in response to a lens movement.

FIG. 6 is an exemplary detail diagram illustrating an alternative embodiment of the aerial imaging system of FIG. 1, wherein the imaging device is supported via a supporting mechanism.

FIG. 7 is an exemplary detail diagram illustrating another alternative embodiment of the aerial imaging system of FIG. 2, wherein the imaging device moves to align the supporting position with the center of gravity.

FIG. 8 is an exemplary flowchart illustrating an embodiment of a configuration method, wherein the aerial imaging system of FIG. 2 is initialized based on centers of gravity.

FIG. 9 is another exemplary flowchart illustrating an alternative embodiment of the configuration method of FIG. 8, wherein the aerial imaging system of FIG. 1 is initialized with an allowable range for each of the lens position settings.

FIG. 10 is an exemplary flowchart illustrating another alternative embodiment of the balancing method of FIG. 2, wherein the supporting position is moved based on a measured load.

FIG. 11 is an exemplary block diagram illustrating another embodiment of the aerial imaging system of FIG. 1, wherein the imaging device is coupled with an unmanned aerial vehicle (“UAV”) via a gimbal.

FIG. 12 is an exemplary block diagram illustrating an embodiment of the gimbal of FIG. 11.

FIG. 13 is an exemplary block diagram illustrating an embodiment of the imaging device of FIG. 11.

FIG. 14 is an exemplary block diagram illustrating an embodiment of the UAV of FIG. 11.

FIG. 15 is an exemplary block diagram illustrating another alternative embodiment of the aerial imaging system of FIG. 11, wherein the UAV communicates with the imaging device and the gimbal.

It should be noted that the figures are not drawn to scale and that elements of similar structures or functions are generally represented by like reference numerals for illustrative purposes throughout the figures. It also should be noted that the figures are only intended to facilitate the description of the embodiments. The figures do not illustrate every aspect of the described embodiments and do not limit the scope of the present disclosure.

### DETAILED DESCRIPTION OF THE EMBODIMENTS

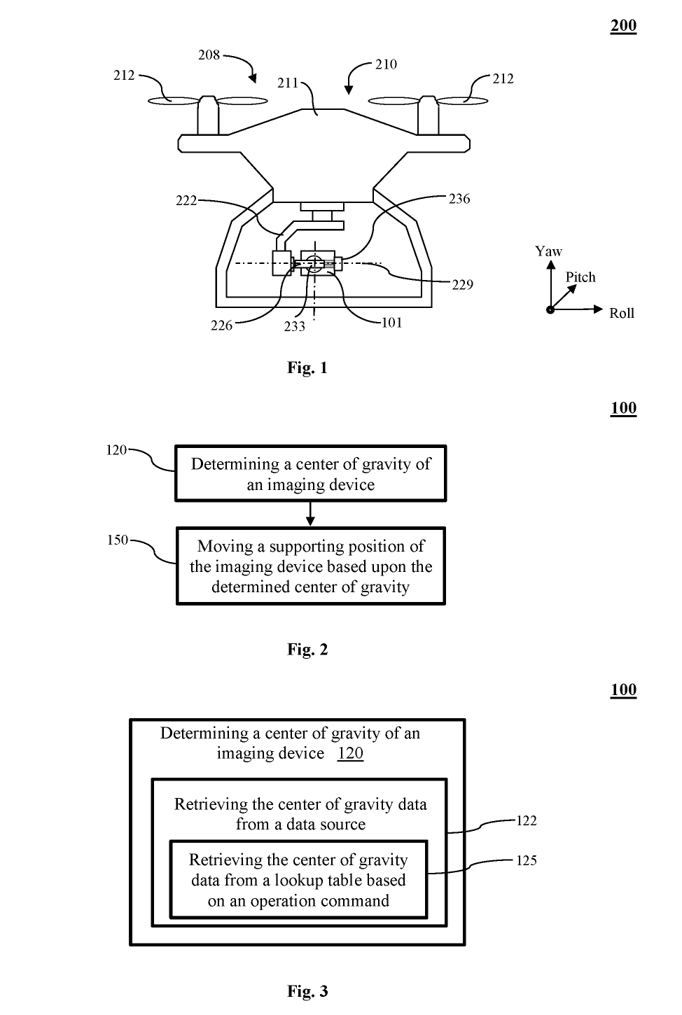

Since currently-available approaches for balancing a center of gravity of an imaging device are complex and require additional weight and a dedicated motor, a support system and method for balancing the center of gravity of the imaging device via moving a supporting position of the imaging device can prove desirable and provide a basis for a wide range of applications such as portable imaging systems, including aerial imaging systems. This result can be achieved, according to one embodiment of an aerial imaging system as shown in FIG. 1.

Turning to FIG. 1, the aerial imaging system 200 is shown as including an imaging device 101 being coupled with an aerial vehicle 208. In FIG. 1, the aerial vehicle 208 can be e.g., an unmanned aerial vehicle (“UAV”) 210 that can capture images from the air.

The imaging device 101 can be associated with the aerial vehicle 208 via a gimbal 222. The gimbal 222 can comprise any conventional type of gimbal and, in some embodiments, is a three-dimensional gimbal that can rotate about three axes, a yaw axis, a pitch axis and a roll axis. The gimbal 222 can include a supporting mechanism 226 that is associated with the imaging device 101. The supporting mechanism 226 can support the imaging device 101 with a movable supporting position 233.

Although shown and described as using the three-dimensional gimbal for purposes of illustration only, any other type of gimbal can be used to associate the imaging device 101 with the aerial vehicle 208, including, but not limited to, a one-dimensional gimbal and/or a two-dimensional gimbal.

The imaging device 101 can be coupled with a lens unit 236 that can zoom in or out by shifting a lens included in the lens unit 236. Thereby, a center of gravity 108 (shown in FIG. 7) of the imaging device 101 can shift along an optical axis 229 during a zooming operation. When the center of gravity 108 of the imaging device 101 is shifted off the supporting position 233, the imaging device 101 can apply a torque force (not shown) to the gimbal 222 via the supporting mechanism 226. The torque force can be unpredictable and/or controllable, and can generate an issue for controlling the gimbal 222. For purposes of alleviating the issue of the unpredictable torque force, the supporting position 233 of the imaging device 101 can be moved in response to a change of the center of gravity 108.

By moving the supporting position 233 in a manner set forth herein, the unpredictable torque can be eliminated or be controlled in an allowable range. Any undesired actions of the supporting mechanism 226 can be prevented or limited, thereby, ensuring a reliable operation of the supporting mechanism 226 and/or the imaging device 101.

The aerial vehicle 208 can comprise a plurality of propellers 212 for providing a lifting force to move the aerial vehicle 208 in a vertical direction. The plurality of propellers 212 can also provide a lateral force to move the aerial vehicle 208 horizontally with or without the movement in the vertical direction. The horizontal movement can include a forward, backward, left and/or right movement in a controlled manner. With the controllable vertical and/or horizontal movements, the aerial vehicle 208 can approach an object (not shown) in any direction in the controlled manner.

The aerial vehicle 208 can comprise a body (or a fuselage) 211 for housing equipment of the aerial vehicle 208, including, but not limited to, one or more control units (not shown) for controlling the aerial vehicle 208, a gimbal 222, and/or an imaging device 101. Alternatively and/or additionally, the gimbal 222 and/or the imaging device 101 can also include one or more control units (not shown) respectively. All control units described herein can include hardware, firmware, software or any combination thereof.

FIG. 2 illustrates an embodiment of an exemplary balancing method 100 for the aerial imaging system 200. As shown in FIG. 2, the balancing method 100 is shown as moving the supporting position 233 of the imaging device 101 based on a center of gravity 108. In FIG. 2, the center of gravity 108 of the imaging device 101 can be determined, at 120.

The imaging device 101 can have an optical zooming capacity that can be achieved via coupling the lens unit 236 (shown in FIG. 1) with the imaging device 101. The lens unit 236, for example, can extend out or retract in when zooming. In other words, a length of the lens unit 236 can change when the imaging device 101 zooms in or zooms out. The movement of the lens unit 236 can cause the center of gravity 108 of the imaging device 101 to shift.

The center of gravity 108 of the imaging device 101 can refer to a selected position along an optical axis 229 (shown in FIG. 1) at which an entire weight of the imaging device 101 can be considered as concentrated. When the imaging device 101 is supported at the selected position, the imaging device 101 can remain in equilibrium along the optical axis 229. In other words, when the imaging device 101 is supported at, or adjacent to, the center of gravity 108, the imaging device 101 applies no or little rotation force about the selected supporting position 233.

The shift of center of gravity 108 of the imaging device 101 can result a misalignment (or a separation) of the center of gravity 108 and the selected supporting position 233. The misalignment can be an issue for a supporting device, for example the gimbal 222 (shown in FIG. 1), of the imaging device 101 because the misalignment can cause an undesired action of the supporting device.

For purposes of alleviating the misalignment of the center of gravity 108 and the supporting position 233, the supporting position 233 of the imaging device 101 can be moved based upon the shift of the center of gravity 108, at 150. Because the center of gravity 108 can be determined, at 120, the supporting position 233 of the imaging device 101 can be controllably moved with the determined center of gravity 108. A result of the movement can eliminate or alleviate the misalignment of the center of gravity 108, in some embodiments at selected points along the optical axis 229.

FIG. 3 illustrates an alternative embodiment of the balancing method 100. Turning to FIG. 3, the center of gravity 108 of the imaging device 101 is determined, at 120. To determine the center of gravity 108 of the imaging device 101, center of gravity data can be retrieved, at 122, from a data source (not shown).

The data source can be associated with a controller (not shown) for controlling the imaging device 101 and/or the movement of the supporting device. The data source can be any suitable data structure stored on a non-transitory computer readable medium. The data structure can include, but is not limited to, a file, a data sheet, a spreadsheet, an XML, file, a database, a lookup table, and/or hard-coded data.

In an embodiment, the data source can be at least partially provided as a lookup table. The center of gravity data can be retrieved from the lookup table, for example, based on an operation command, at 155. An exemplary lookup table is illustrated in Table 1.

TABLE 1

| | |
|---|---|
| Operation Command/Input | Output |

| Focal Length | Focus Position | Center of Gravity |
|---|---|---|
| 24 | 1 | 2 |
| 24 | 10 | 8 |
| 24 | Infinite | 12 |
| 35 | 1 | 3 |
| 35 | 10 | 5 |
| 35 | Infinite | 9 |
| 50 | 1 | 4 |
| 50 | 10 | 10 |

The operation command can be received as an input for a data retrieve from the data source and can include a focal length and a focus position. An output of the retrieve can be the center of gravity 108. In Table 1, e.g., when the focal length is twenty-four millimeters and the focus position is at a focus position “1,” the center of gravity 108 can be at a center of gravity position “2.” Conversely, when the focal length is twenty-four millimeters and the focus position is at a focus position “Infinite,” the center of gravity 108 can be at a position “12” etc.

Although shown and described as including eight focal lengths and focus positions for purposes of illustration only, the lookup table can include any predetermined number of focal length and focus position combinations. By increasing the number of focal length and focus position combinations, the balancing of the center of gravity 108 can be performed in a smoother manner.

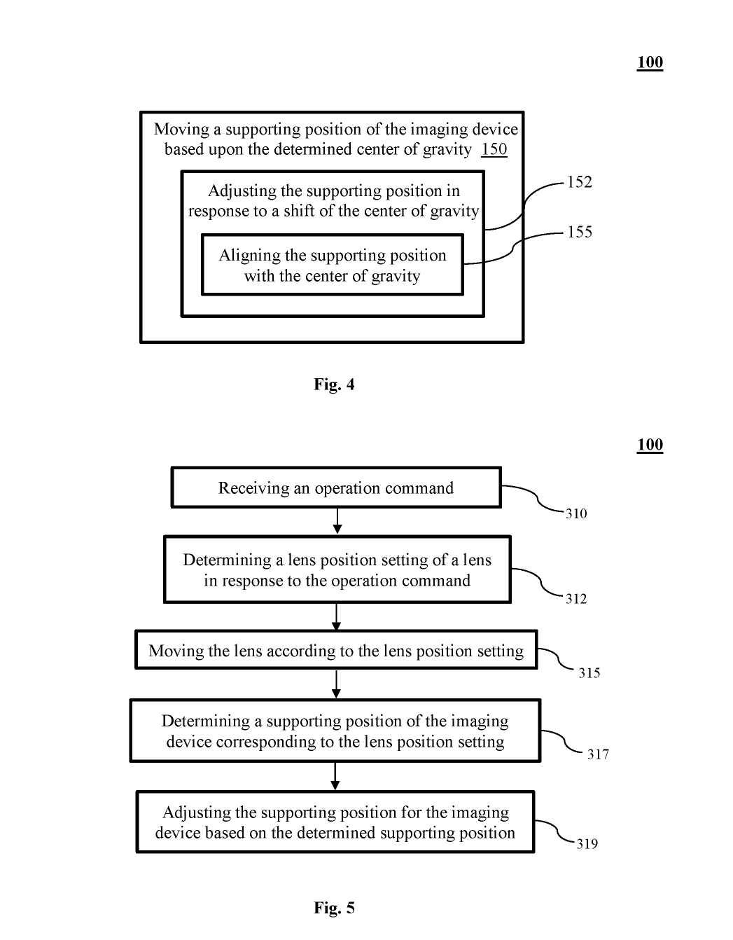

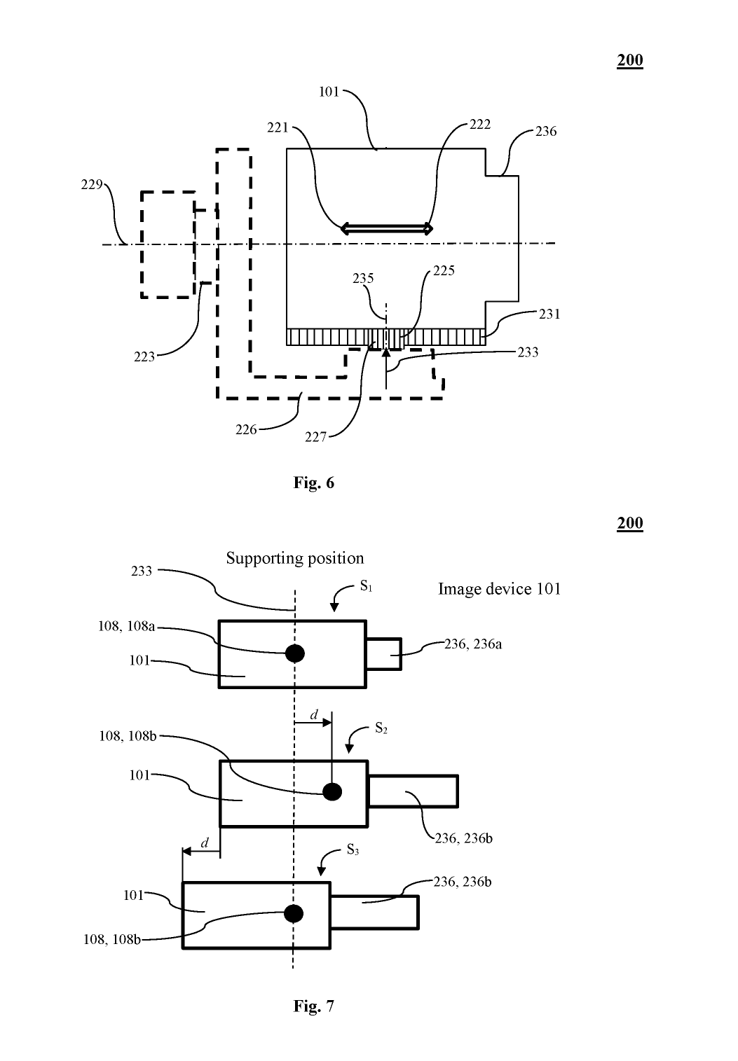

FIG. 4 illustrates an alternative embodiment of the balancing method 100. Turning to FIG. 4, the supporting position 233 (shown I FIG. 6) of the imaging device 101 is moved based upon the center of gravity 108, at 150. In FIG. 4, the supporting position 233 can be adjusted in response to a change of the center of gravity 108.

The supporting position 233 can be a position along an optical axis 229 (shown in FIG. 1) at which the imaging device 101 is supported. The supporting position 233 can be provided via a supporting device, e.g., a gimbal 222 that couples the imaging device 101 with an aerial vehicle 208, e.g., the UAV 210 (collectively shown in FIG. 5). The supporting position 233 can be measured relative a selected position on the optical axis 229 of the imaging device 101. The supporting position 233 can be movable with respect to the imaging device 101. When the center of gravity 108 of the imaging device 101 is expected to shift, the supporting position 233 can be adjusted, at 152, in response to the shift of the center of gravity 108.

In adjusting the supporting position 233, the supporting position 233 can be aligned with the center of gravity 108, at 155. When the imaging device 101 zooms in or out and the center of gravity 108 is determined, the supporting position 233 can be moved to or toward the determined center of gravity 108 either before or after a movement of the lens unit 236. In some embodiments, the supporting position 233 and the lens unit 236 can be moved in a simultaneous manner.

Although shown and described as aligning the supporting position 233 with the center of gravity 108 for purposes of illustration only, the supporting position 233 can be moved within a selected allowable range about the center of gravity 108.

FIG. 5 illustrates another alternative embodiment of the balancing method 100. Turning to FIG. 5, the supporting position 233 of the imaging device 101 is adjusted to align with the center of gravity 108 of the imaging device 101 in response to a lens movement. In FIG. 5, the operation command can be received, at 310.

The operation command can include, for example, a zoom-in command or a zoom-out command being received by the imaging device 101. In some embodiments, the operation command can be received from a controller (not shown). The operation command can include, but is not limited to, a focal length and/or a focus position. Alternatively and/or additionally, the operation command can include other information that can derive the focal length and/or the focus position, e.g., magnification.

A lens position setting in response to the operation command can be determined, at 312. In other words, the lens position setting can be determined based on the information contained in the operation command. The lens position setting can be represented, e.g., by the focal length and/or the focus position. The lens position setting can be determined in any suitable manner corresponding to the operation command.

At 315, the lens unit 236 (shown in FIG. 1) can be moved according to the determined lens position setting. The lens unit 236 can be moved in any suitable manner for zooming, e.g., via a zooming mechanism of the lens unit 236 and/or the imaging device 101.

The supporting position 233 corresponding to the lens position setting can be determined, at 317. The supporting position 233 can be a position where the imaging device 101 is supported and, thereby, can be relative to the imaging device 101. The supporting position 233 can be determined in the manner set forth herein with reference to FIG. 2, including, but not limited to, retrieving the center of gravity 108 from a lookup table, a spreadsheet, a flat file and/or a database based on the lens position setting.

At 319, the supporting position 233 of the imaging device 101 can be adjusted based on the determined supporting position 233. The supporting position 233 can be moved to align with the determined supporting position 233 in a similar manner as set forth herein with reference to FIG. 3.

Although shown and described as moving the lens unit 236 according to the lens position setting before adjusting the supporting position 233 for purposes of illustration only, the lens unit 236 and the supporting position 233 can be moved or adjusted in any order sequentially or simultaneously.

FIG. 6 illustrates an alternative embodiment of the aerial imaging system 200. Turning to FIG. 6, the imaging device 101 is shown as supported via the supporting mechanism 226. The supporting mechanism 226 has a rack and pinion 225. In FIG. 6, the imaging device 101 can move along an optical axis 229 of the imaging device 101.

The imaging device 101 can move in a first direction 221 along the optical axis 229 and/or move in a second direction 222 that is along the optical axis 229 and that is opposite to the first direction 221. In some embodiments, a sliding mechanism (not shown) can be provided to guide the imaging device 101 to move along the optical axis 229. The sliding mechanism can help ensure a smooth sliding of the imaging device 101.

The rack and pinion 225 can be used to drive the imaging device 101 to move along the optical axis 229. The rack and pinion 225 can be a type of linear actuator that can convert rotational motion into linear motion. The rack and pinion 225 can comprises a rack 231 and a pinion 227. The pinion 227 can be driven by a motor (not shown) to rotate about an axis 235 that is perpendicular to the rack 231.

The pinion 227 can have gears, and at least a portion of the gears can engage with selected gears of the rack 231. When the motor rotates, the pinion 227 rotates about the axis 235, and the gears of the pinion 227 can push the gears of the rack 231. The rack 231 can then move the imaging device 101 along the optical axis 229. The motor can be any type of controllable motor that can rotate in counterclockwise direction and/or clockwise direction, e.g., a stepper motor. In some embodiments, the rotation of the motor can be controlled to achieve precise position and/or speed.

The rack 231 and/or the pinion 227 can be made of any material, including, but not limited to, a metallic material and/or a non-metallic material, e.g., a plastic material. The pinion 227 can be driven by the motor in a direct manner or an indirect manner. When driven in the direct manner, the motor and the pinion 227 can couple with each other directly, e.g., via sharing the axis 235. When driven in the indirect manner, the motor can associate with the pinion 227 via a gear system (not shown). The gear system can pass the rotation to the pinion 227 and can adjust an output speed of the motor, e.g., reduce the output speed.

In some embodiments, a supporting position 233 of the imaging device 101 can overlap the axis 235 of the pinion 227. When the pinion 227 rotates, the imaging device 101 can move along the optical axis 229 and, as a result, the supporting position 233 can be shifted with respect to the imaging device 101.

Although shown and described as the supporting position 233 overlapping the axis 235 for purposes of illustration only, the supporting position 233 and/or the axis 235 can be arranged separately in any suitable positions along the optical axis 229. Alternatively and/or additionally, more than one pinion 227 and/or more than one supporting position 233 can be provided to controllably shift the supporting position 233.

FIG. 7 illustrates another alternative embodiment of the aerial imaging system 200. Turning to FIG. 7, the imaging device 101 can move to align the supporting position 233 with the center of gravity 108. In FIG. 7, the imaging device 101 can have a lens unit 236 for providing a zooming capacity.

The lens unit 236 can be a mechanical assembly of lens elements for which the focal length can be varied. The lens unit 236 can be extended or retracted when the imaging device 101 zooms in or zooms out. A first status S₁ of the imaging device 101 shows the lens unit 236 is in a zoom-in position (or a retracted position), and a second status S₂ and a third status S₁ show the lens unit 236 is in a zoom-out position (or an extended position).

At the first status S₁, the lens unit 236 can be in a position before a zooming action. For example, the lens unit 236 can be in a zoom-in position 236a, and the center of gravity 108 of the imaging device 101 can be at 108a. The supporting position 233 can be aligned with the center of gravity 108a. At the first status S₁, the imaging device 101 can apply a force on the supporting position 233 and cannot generate a torque to cause the imaging device 101 to rotate about the supporting position 233. In other words, the imaging device 101 does not apply a rotating force to a supporting device, e.g., a gimbal 222 (shown in FIG. 1), at the first status S₁. The supporting device can be operated with little interference of the imaging device 101.

At the second status S₂, the lens unit 236 can conduct a zooming action but the supporting position 233 is not adjusted accordingly. For example, the lens unit 236 can be in a zoom-out position, 236b, and the center of gravity 108 of the imaging device 101 can be shifted to 108b. The supporting position 233, when not moved with respect to the imaging device 101, can be misaligned with the center of gravity 108b. The supporting position 233 can separate the center of gravity 108b by a distance d that is the shift of the center of gravity 108 being generated by the zooming action of the lens unit 236. The separation of the supporting position 233 and the center of gravity 108 can generate a rotation torque t=m×d along the optical axis 229 (shown in FIG. 1) about the supporting position 233. In other words, the imaging device 101 can apply a rotating force to the supporting device, e.g., the gimbal 222, at the second status S₂ and thus interfere with operation of the supporting device.

At the third status S₃, the lens unit 236 can be adjusted to align with the supporting position 233. For example, the lens unit 236 can be still in the zoom-out position, 236b, and the center of gravity 108 of the imaging device 101 can be still at 108b. For purposes of eliminating the torque generated from the separation of the supporting position 233 and the center of gravity 108, the supporting position 233 can be moved in a direction that is opposite to the shift of the center of gravity 108. In some embodiments, the supporting position 233 can be aligned with the center of gravity 108 via moving the supporting position 233 by the distance d. The supporting position 233 is along the optical axis 229 and relative to the imaging device 101. Therefore, the movement of the supporting position 233 can be achieved by moving the imaging device 101 with respect to the supporting position 233.

Although shown and described as moving the imaging device 101 for purposes of illustration only, the supporting position 233 can also be moved by shifting the supporting device.

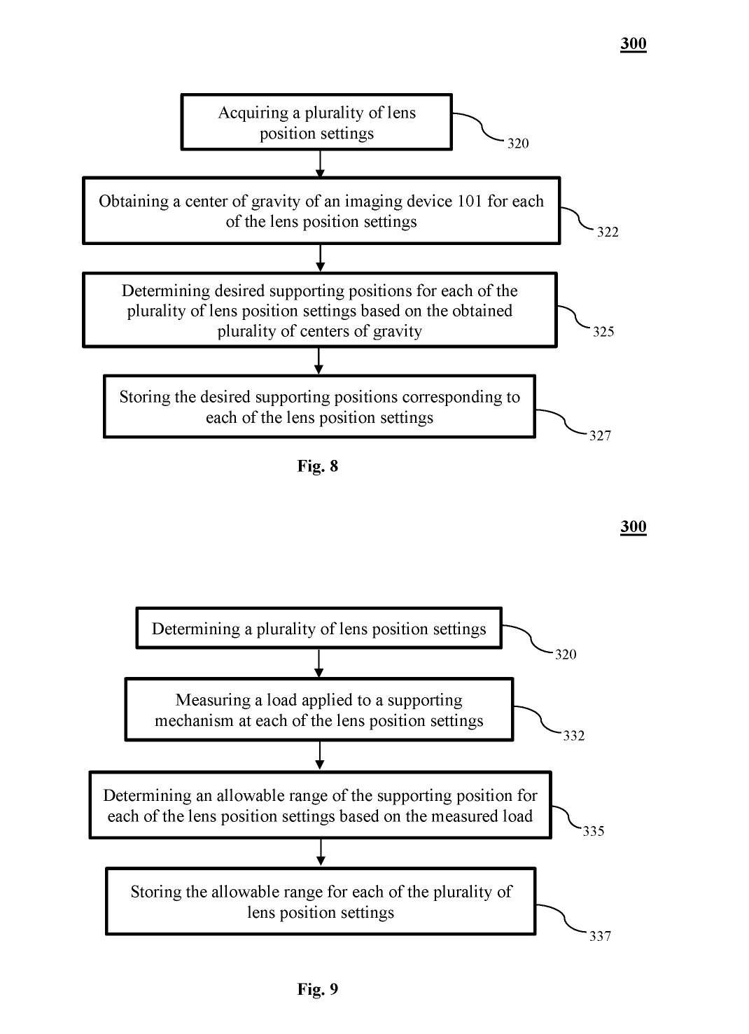

FIG. 8 illustrates an embodiment of an exemplary configuration method 300. Turning to FIG. 8, the aerial imaging system 200 is initialized based on the centers of gravity 108. A desired supporting position for each of the lens position settings of a lens unit 236 is determined based on the center of gravity 108. In FIG. 8, the plurality of lens position settings can be acquired, at 320.

The plurality of lens position settings can be acquired in any suitable manners. In some embodiments, each of the lens position settings can be acquired by including all possible combinations of focal lengths and focus positions that can be available for a selected lens unit 236. In some other embodiments, the lens position settings can be acquired from statistical data, e.g., deriving frequently used combinations of focal lengths and the focus positions from all of the possible combinations based upon statistical data. Alternatively and/or additionally, the lens position settings can be acquired by experience and/or preference of a manufacturer and/or a user.

For each of the lens position settings, a center of gravity 108 (shown in FIG. 7) of an imaging device 101 can be obtained, at 322. As shown and described with reference to FIG. 6, the center of gravity 108 can be a position along the optical axis 229 of the imaging device 101. In some embodiments, the center of gravity 108 can be calculated via any suitable algorithms and/or can be measured via any suitable devices for each of the lens position settings.

The desired supporting positions for the plurality of lens position settings can be determined, at 325, based on the obtained plurality of centers of gravity 108. As set forth herein, each of the desired supporting positions can be determined by aligning with the center of gravity 108 for the lens position setting. Alternatively and/or additionally, the desired supporting positions can be determined based on other selected factors in addition to the center of gravity 108. Such factors can include, but are not limited to, parameters of a supporting device and/or parameters of the lens unit 236 coupled with the imaging device 101.

At 327, the determined desired supporting positions corresponding to each of the lens position settings can be stored. The desired supporting positions can be stored in any not-transitory media that can be accessible by a processor (not shown), including, but not limited to, a file, a data sheet, a spreadsheet, an XML file, a database, a lookup table, be hard-coded in software or the like.

FIG. 9 illustrates another embodiment of the configuration method 300. Turning to FIG. 9, the aerial imaging system 200 can be initialized with an allowable range of the supporting position 233 for each of the lens position settings. The allowable range for each of the lens position settings of the lens unit 236 (shown in FIG. 7) can be determined based on a load applied to the supporting mechanism 226. In FIG. 9, a plurality of lens position settings can be determined, at 320. The lens position settings can be determined in a similar manner as set forth with reference to FIG. 8.

A load being applied to the supporting mechanism 226 at each of lens position settings can be measured, at 332. The load can be a torque force along an optical axis 229 (shown in FIG. 1) about the supporting position 233. Since each of the lens position settings can have a desired supporting position, an adjacent load between any two adjacent lens position settings can be determined. The adjacent load can be determined as the supporting position 233 being at the desired supporting position of one of the lens position settings and the lens unit 236 being at the other lens position setting.

A load between any two lens position settings can be determined by summing all of the adjacent loads between the two lens position settings. For example, for lens positions {P₁, P₂, P₃, . . . Pᵢ, Pᵢ₊₁, Pᵢ₊₂, Pᵢ₊₃, . . . Pₙ}, the adjacent loads can be {L₁, L₂, . . . Lᵢ, Lᵢ₊₁, Lᵢ₊₂, . . . Lₙ₋₁}, where L₁ is a load between P₁ and P₂, L₂ is a load between P₂ and P₃, Lᵢ is a load between Pᵢ and Pᵢ₊₁. A load between P₁ and P₃ can be (L₁+L₂), and a load between Pᵢ and Pᵢ₊₃ can be (Lᵢ+Lᵢ₊₁+Lᵢ₊₃). Therefore, at 332, all of the adjacent loads between any two adjacent lens position settings can be determined. Thereby, the load between any two lens position settings can be calculated based on the adjacent loads.

An allowable range of the supporting position 233 can be determined, at 335, for each of the lens position settings based on the measured loads. The allowable range of the supporting position 233 can be directly related to the supporting mechanism 226 and can be decided by comparing the load between two lens position settings with a maximum allowable load threshold LT₁. For example, for the lens position setting Pᵢ₊₁, if (Lᵢ₋₁+Lᵢ₊₂) is less than or equal to LT₁ and (Lᵢ₊₁+Lᵢ₊₂+Lᵢ₊₂) is greater than LT₁, an upper limit of the allowable range can be Pᵢ₊₃. Additionally, if (Lᵢ₋₁+Lᵢ₋₂) is less than or equal to LT₁ and (Lᵢ₋+Lᵢ₋₂+Lᵢ₋₃) is greater than LT₁, a lower limit of the allowable range can be Pᵢ₋₂. Thereby, the allowable range can be {Pᵢ₋₂, Pᵢ₊₃}.

At 327, the determined allowable range corresponding to each of the lens position settings can be stored, at 337, in a manner as set forth with reference to FIG. 8. Although shown and described as being storing the allowable ranges for purposes of illustration only, the adjacent loads and/or the measured loads between any two lens positions can be also stored.

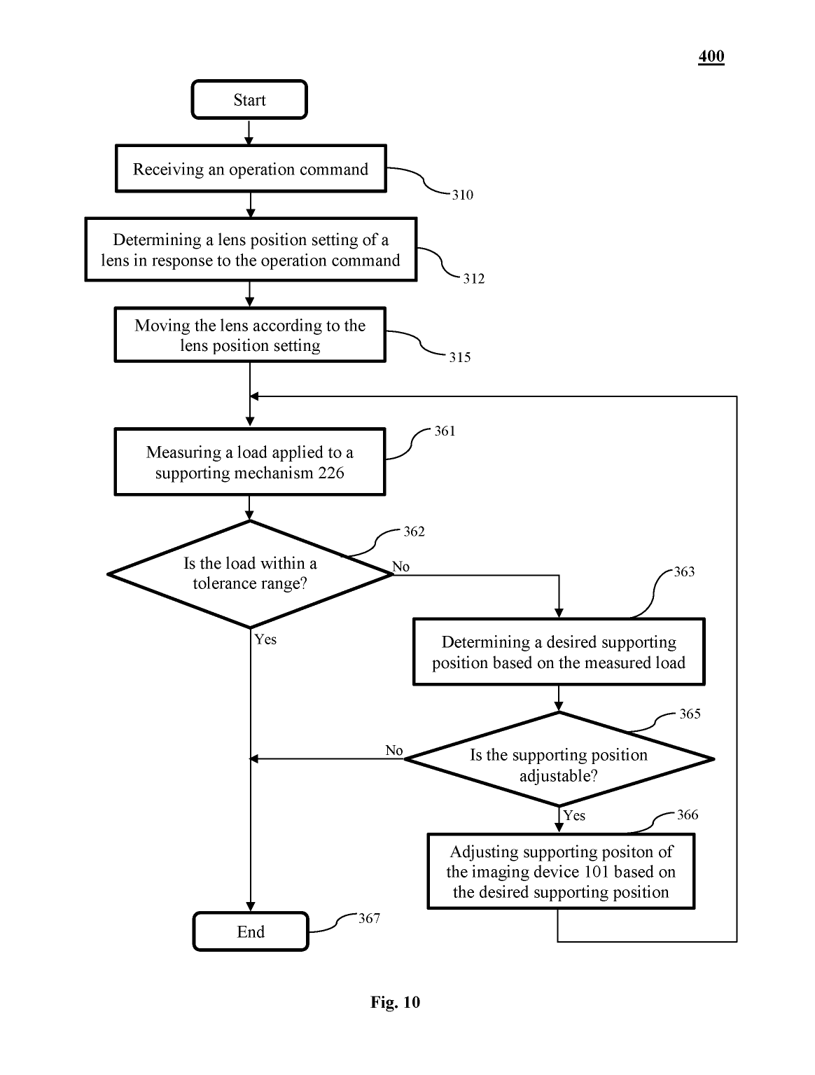

FIG. 10 illustrates another alternative embodiment of the balancing method 100. Turning to FIG. 10, the supporting position 233 is moved based on the measured load. In FIG. 10, as shown and described with reference to FIG. 4, an operation command can be received, at 310, and can include a command for zooming a lens unit 236.

As set forth with reference to FIG. 4, a lens position setting in response to the operation command can be determined, at 312, and the lens unit 236 can be moved to the lens position setting, at 315. The lens position setting can include a focal length and/or a focus position.

At 361, a load applied to a supporting mechanism 226 can be measured. The load can include a torque force about the supporting position 233 (shown in FIG. 1). The torque force, for example, can be generated when the center of gravity 108 (shown in FIG. 7) is not aligned with the supporting position 233. The load can vary due to a difference of the operation command. For example, when the operation command demands the lens unit 236 to extend out or retract in passing a certain threshold, the center of gravity 108 can shift and the load can become heavy with respect to the supporting mechanism 226.

At 362, whether the load is within a tolerance range can be decided. The tolerance range can be defined e.g., with a maximum load threshold. Stated somewhat differently, when the load is less than or equal to the maximum load threshold, the load can be determined as within the tolerance range. When the load is greater than the maximum load threshold, the load can be determined to be outside the tolerance range. The maximum load threshold can be measured in a torque unit, e.g., gram-millimeter. Alternatively and/or additionally, the maximum load threshold can also be measured in a length unit, e.g., millimeter, because a mass of the imaging device 101 can be a constant. At 362, if the load is determined to be within the tolerance range, the supporting position 233 can be maintained.

If the load is determined to be outside the tolerance range, a desired supporting position, that can offset at least a portion of the load, can be determined, at 363, based on the measured load and/or the center of gravity 108. The desired supporting position can be the center of gravity 108 of the imaging device 101, such that the load would be totally offset. In some embodiments, the desired supporting position can be different with the center of gravity 108. In some embodiments, the desired supporting position can be closer to the center of gravity 108 than the supporting position 233 such that the load would be reduced if the supporting position 233 is moved to the desired supporting position.

At 365, whether the supporting position 233 can be adjustable is determined, at 365. In some cases, the supporting positions 233 can be not adjustable, e.g., when the supporting position 108 is restricted by mechanical limitations. In some embodiments, an attitude status of a supporting device, e.g., the gimbal 222 (shown in FIG. 4), can be considered when deciding whether the supporting position 233 is adjustable, at 365. Such attitude status can include, but is not limited to, a roll angle, a pitch angle and a yaw angle.

If the supporting position 233 is determined to be not adjustable, the supporting position 233 can be maintained. When the supporting position 233 is determined to be adjustable, the supporting position 233 can be moved to or toward the desired supporting position. In some embodiments, the supporting position 233 can be moved, such that the supporting position 233 is aligned with the desired supporting position. In some other embodiments, the supporting position 233 can be moved to a maximum adjustable extend that is decided, e.g., by the mechanical restriction of a supporting mechanism 226, e.g., the rack and pinion 225 (shown in FIG. 6).

Although shown and described as moving the lens unit 236 before adjusting the supporting position 233 for purposes of illustration only, supporting position 233 can be adjusted before the lens unit 236 moves or simultaneously with the lens unit 236.

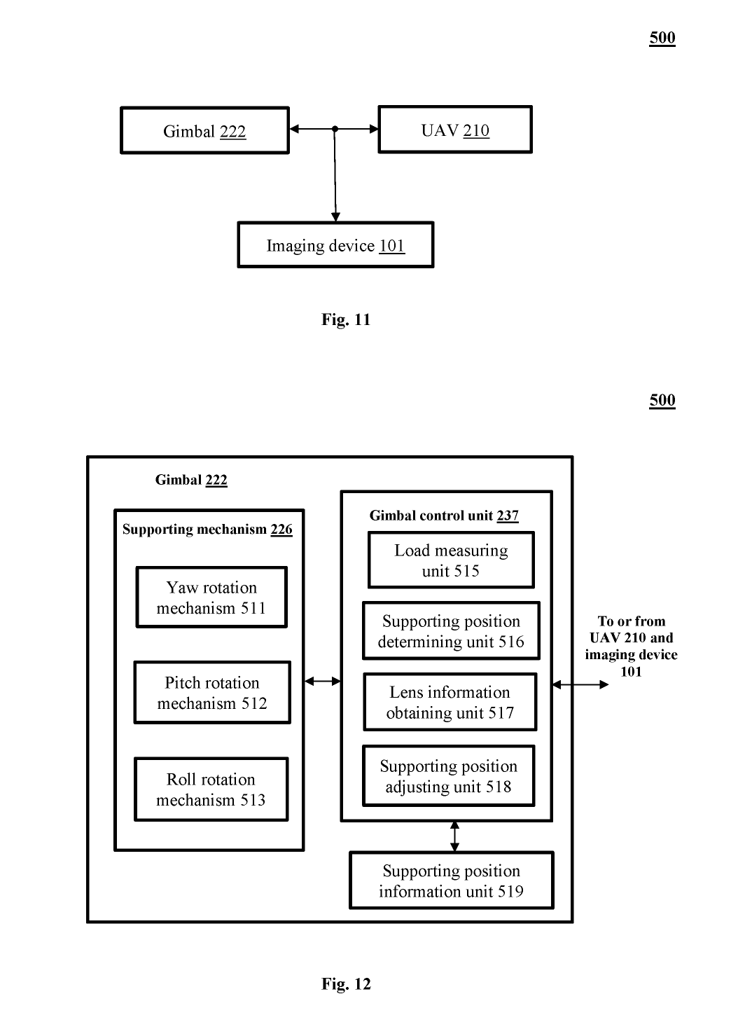

FIG. 11 illustrates an embodiment of an exemplary aerial imaging system 500. Turning to FIG. 11, the aerial imaging system 500 is shown as coupling the imaging device 101 with a UAV 210 via a gimbal 222. In FIG. 11, the gimbal 222, the UAV 210 and the imaging device 101 can communicate with each other for purposes of balancing the imaging device 101 during a zooming action.

The gimbal 222 can be a three-dimensional gimbal that provides three actions, a yaw, a pitch and a roll. Thereby, an attitude of the gimbal 222 can include a yaw angle, a pitch angle and a roll angle. The gimbal 222 can transmit its attitude status to the imaging device 101 and/or the UAV 210 for any selected purpose, e.g., for moving the supporting position 233 (shown in FIG. 1) of the imaging device 101. The gimbal 222 can also receive information from the imaging device 101 and/or the UAV 210. Such information can include, but is not limited to, lens position data and the like.

The imaging device 101 can be provided in the manner set forth with reference to FIG. 4. The imaging device 101 can be coupled with one or more lenses and can have the center of gravity 108 (shown in FIG. 6). The imaging device 101 can maintain and/or communicate information regarding the lens position data and/or the center of gravity 108 to the gimbal 222 and/or the UAV 210. The imaging device 101 can also receive information from the gimbal 222 and/or the UAV 210, including, but not limited to, the lens position data and/or the center of gravity 108.

The UAV 210 can be a control center of the aerial imaging system 500 and can contain flight status of the UAV 210, such as, velocity, direction and/or altitude. The UAV 210 can communicate the flight status to the gimbal 222 and/or the imaging device 101. The UAV 210 can also communicate an operation command to the gimbal 222 and/or the imaging device 101, e.g., a zoom operation command to the imaging device 101 and/or an attitude command to the gimbal 222. The UAV 210 can also receive information from the gimbal 222, such as, the attitude status, and receive information from the imaging device 101, such as, the center of gravity 108 and the lens position data and the like.

Although shown and described as communicating among the gimbal 222, the UAV 210 and the imaging device 101 for purposes of illustration only, the aerial imaging system 500 can communicate with other devices, e.g., a controller to initiate the operation command.

FIG. 12 illustrates an alternative embodiment of the gimbal 222 of the aerial imaging system 500. Turning to FIG. 12, the gimbal 222 of the aerial imaging system 500 can include a supporting mechanism 226 and a gimbal control unit 237. In FIG. 12, the supporting mechanism 226 can include up to three rotation mechanisms for conducting a yaw action, a pitch action and/or a roll action.

For purposes of conducting the actions, the supporting mechanism 226 can include a yaw rotation mechanism 511, a pitch rotation mechanism 512 and a roll rotation mechanism 513. An attitude of the gimbal 222 can be defined by a status of the rotation mechanisms 511, 512, 513. For example, the status of the gimbal 222 can include a yaw angle defined by a position of the yaw rotation mechanism 511, a pitch angle defined by a position of the pitch rotation mechanism 512 and/or a roll angle defined by a position of the roll rotation mechanism 513.

Alternatively and/or additionally, the supporting mechanism 226 can provide the rotation information to the gimbal control unit 237 for deciding, e.g., a load. The supporting mechanism 226 can also receive information, e.g., a command to rotate any of the three rotation mechanisms 511, 512, 513. The command can be received from the gimbal control unit 237.

Additionally, the gimbal 222 can include a supporting position information unit 519 for acquiring and providing information regarding the supporting position 233 (shown in FIG. 1). The supporting position 233 can be acquired via a sensor (not shown), e.g. a position sensor. The supporting position information can be provided to the gimbal control unit 237.

The gimbal control unit 237 can obtain the information from the supporting mechanism 226, in real time or at any selected moment, via a supporting position determining unit 516. The supporting position determining unit 516 can include hardware, firmware, software or any combination thereof. The supporting position determining unit 516 can determine the supporting position 233 via any suitable manner, e.g., via the supporting position information unit 519.

The gimbal control unit 237 can include a load measuring unit 515 for measuring a torque load applied to the supporting mechanism 226. The load can be measured via a torque measuring sensor (not shown) coupled with the supporting mechanism 226 and/or can be calculated based on the supporting position 233 and a position of the center of gravity 108 of the imaging device 101 (collectively shown in FIG. 6).

The position of the center of gravity 108 can be acquired via a lens information obtaining unit 517 included in the gimbal control unit 237. The lens information obtaining unit 517 can receive lens position information from the UAV 210 and/or from the imaging device 101. Additionally, the lens position information obtaining unit 517 can either acquire the center of gravity 108 or determine the center of gravity 108 based on the lens position information and a mass of the imaging device 101.

Alternatively and/or additionally, the gimbal control unit 237 can include a supporting position adjusting unit 518. The supporting position adjusting unit 518 can determine a desired supporting position based upon the information acquired via the other units 515, 516, 517, 518. The desired supporting position can be determined, based on the center of gravity 108, the load and/or the lens position information, in a similar manner as set forth herein.

FIG. 13 illustrates another alternative embodiment of the imaging device 101 of the aerial imaging system 500. Turning to FIG. 13, the imaging device 101 is shown as including an imaging device body 151, a lens control unit 153 and a lens moving mechanism 155. In FIG. 13, the imaging device body 151 can include an imaging sensor 523, an imaging control unit 525 and a memory 526.

The imaging sensor 523 can be used to capture images. The memory 526 can be any non-transitory media that is readable to the imaging control unit 525 and can be used to store the captured images and any data for operating the imaging device 101. The memory 526 can be removable from the imaging device body 151. The imaging control unit 525 can comprise one or more processors that are configured to, individually or collectively, perform functions of the imaging device 101. The functions can include, but are not limited to, receiving a command from the UAV 210, communicating with the gimbal 222 and/or controlling a zoom lens 238.

The lens control unit 153 can be associated with the imaging device body 151 and can receive a control command from the imaging device body 151, including, but not limited to, setting a focal length and/or a focus position of the zoom lens 238. The lens control unit 153 can execute the control command via the lens moving mechanism 155, e.g., set the focal length and/or the focus position of the zoom lens 238.

Alternatively and/or additionally, the lens control unit 153 can be associated with a lens position setting information unit 521 and/or a center of gravity information unit 522. The lens position setting information unit 521 can store, e.g., combinations of focal lengths and focus positions, corresponding zoom positions and the like. Additionally, the lens position setting information unit 521 can store a current lens position.

The center of gravity information unit 521 can store a center of gravity 108 corresponding to each selected combination of the focal lengths and focus positions. The center of gravity information being stored in the center of gravity information unit 521 can include a center of gravity 108 of the imaging device 101. The center of gravity data and each corresponding combination of the focal lengths and focus positions can be stored in a form of a lookup table, a spreadsheet, a flat file and/or a database.

The lens control unit 152 can control the lens moving mechanism 155 to set zoom lens 238 according to the lens position setting, e.g., the focal length and the focus position retrieved from the lens position setting information unit 521. In some embodiments, the lens control unit 152 can automatically micro-tune the zoom lens 238, e.g., to the focus position.

The center of gravity data can be retrieved from the center of gravity information unit 522, via the lens control unit 153, by the imaging control unit 525 of the imaging device body 151 and be transmitted to the UAV 210 and/or the gimbal 222.

Although shown and described as using one zoom lens 238 for purposes of illustration only, a plurality of zoom lenses 238 can be controlled by the lens control unit 153 via the lens moving mechanism 155. In a case of the plurality of zoom lenses 238, the lens position setting information unit 521 and the center of gravity information unit 522 can store related information for the plurality of zoom lenses 238.

Although shown and described as separating the imaging device body 151, the lens control unit 153 and the lens moving mechanism 155 for purposes of illustration only, the lens control unit 153 can be integrated with the lens moving mechanism 155 and/or the imaging device body 151.

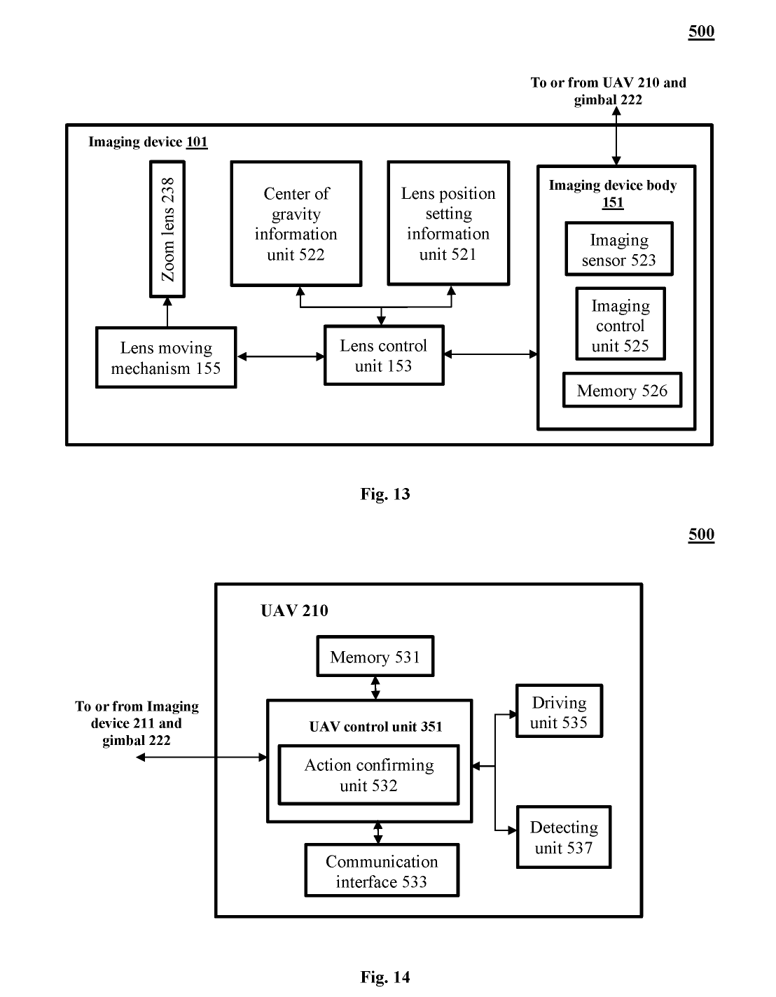

FIG. 14 illustrates another alternative embodiment of the UAV 210 of the aerial imaging system 500. Turning to FIG. 14, the UAV 210 is shown as including a UAV control unit 351, a driving unit 535 and a detecting unit 537. In FIG. 14, the driving unit 535 can include the plurality of propellers 212 (shown in FIG. 1) for providing lifting force and horizontal force for driving the UAV 210.

The detecting unit 537 can acquire a status of the UAV 210, including, but not limited to, an altitude, a velocity and an attitude of the UAV 210. The attitude can include, but is not limited to, a yaw angle, a pitch angle and/or a roll angle of the UAV 210. The detected status of the UAV 210 can be taken into consideration for determining a load of the imaging device 101 (shown in FIG. 13).

The UAV 210 can also include a memory 531 that can be a non-transitory medium for storing data relevant to operations of the UAV 210, the gimbal 222 (shown in FIG. 12) and/or the imaging device 101. The memory 531 can be removable from the UAV 210. The UAV 210 can include a communication interface 533 for receiving operation commands, via a wireless connection (not shown), including, but not limited to, UAV operation commands, gimbal operation commands and/or imaging commands, e.g., a zooming command.

The UAV 210 can include a UAV control unit 351 that can include one or more processors for controlling actions of the UAV 210, the gimbal 222 and/or the imaging device 101. The UAV control unit 351 can include an action confirming unit 532 for analyzing a message received via the communication interface 533. In some embodiments, when the message is received, the action confirming unit 532 can decide whether the message comprise an operation command. If the message comprises the operation command, the action confirming unit 532 can determine a type of the operation command and what device the command is targeted.

The UAV control unit 351 can communicate with the gimbal 222 and/or the imaging device 101. When the operation command is determined to be a UAV command, the UAV control unit 351 can execute the operation command. When the operation command is determined to be a gimbal command, the UAV control unit 351 can deliver the operation command to the gimbal 222. When the operation command is determined to be an imaging device command, the UAV control unit 351 can deliver the operation command to the imaging device 101 and/or the gimbal 222.

Alternatively and/or additionally, the UAV control unit 351 can retrieve information from the gimbal 222 and/or the imaging device 101, e.g., an attitude status of the gimbal 222, a supporting position 233 of the imaging device 101, and/or a lens position setting of the imaging device 101. The retrieved information can be analyzed by the UAV control unit 351 and/or be communicated to a remote location via the wireless connection.

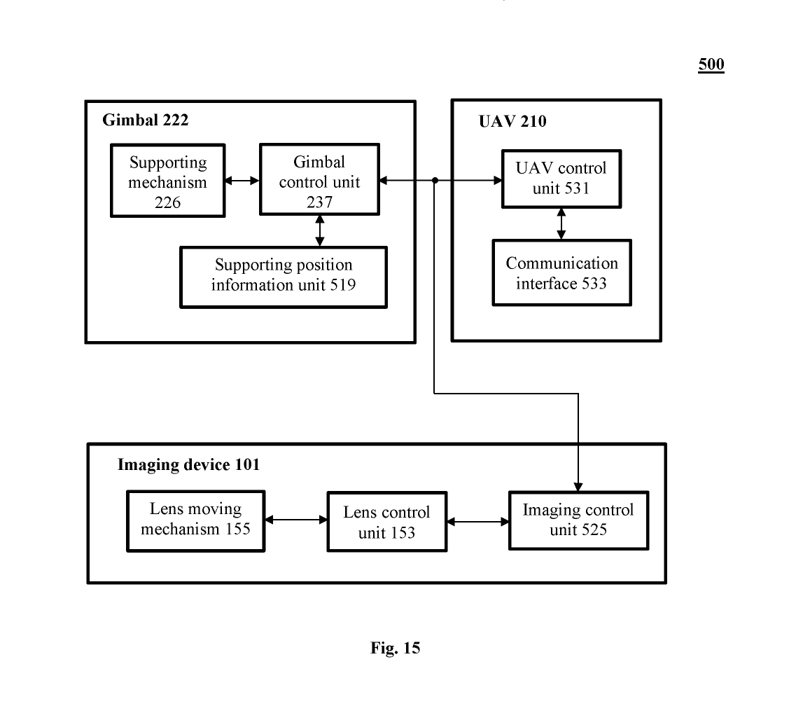

FIG. 15 illustrates another alternative embodiment of the aerial imaging system 500. Turning to FIG. 15, wherein the UAV 210 communicates with the imaging device 101 and the gimbal 222. In FIG. 15, the UAV 210 can include a communication interface 533 for receiving an operation command.

The operation command is analyzed via the UAV control unit 531. When the operation command is determined to be a zooming command, the UAV control unit 531 can transmit the operation command to the imaging device 101. The zooming command can include zooming information, e.g., a zoom level, a view depth, a focal length and/or a focus position etc. The imaging control unit 525 of the imaging device 101 can transmit the operation command to the lens control unit 153.

The lens control unit 153 can decide a lens position, including the focal length and/or the focus position, based on the zooming command. Additionally, the lens control unit 153 can control the lens moving mechanism 155 to move the zoom lens 238 (shown in FIG. 13) to the lens position. The lens control unit 153 can also have access to a medium, e.g., a lookup table that stores center of gravity information. The center of gravity information can comprise the center of gravity 108 (shown in FIG. 6) of the imaging device 101 at a selected lens position setting. The center of gravity information can be retrieved based on the lens position, e.g., the focal length and/or the focus position.

The center of gravity information can be transmitted via the imaging control unit 525 to a gimbal control unit 237 of the gimbal 222. The gimbal control unit 237 can take a measurement of a load applied by the imaging device 101 to the supporting mechanism 226 and decide whether the load is within a tolerance range, e.g., whether the load is greater than a maximum load threshold. If the load is determined to be less than or equal to the maximum load threshold, the gimbal control unit 237 can decide to maintain the supporting position 233 (shown in FIG. 1). Conversely, if the load is determined to be greater than the maximum load threshold, the gimbal control unit 237 can decide to move the supporting position 233 toward the center of gravity 108.

Although shown and described as the gimbal control unit 237 measures the load for purposes of illustration only, the load can be calculated by the gimbal control unit 237 based on the center of gravity 108 and a mass of the imaging device 101.

When the gimbal control unit 237 decides to move the supporting position 233 (shown in FIG. 1), the gimbal control unit 237 can determine whether the supporting position 233 can be adjustable. If the supporting position 233 is determined to be adjustable, the gimbal control unit 237 can control the supporting mechanism 226 to move the supporting position 233 to or toward the center of gravity 108.

Although shown and described as communicating the zooming command and the center or gravity 108 for illustration only, the UAV 210, the gimbal 222 and the imaging device 101 can exchange any needed information for operating the UAV 210, the gimbal 222 and/or the imaging device 101.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A method for balancing an imaging device, comprising:
determining a center of gravity of the imaging device; and
moving a supporting position of the imaging device based upon the determined center of gravity.

2. The method of claim 1, wherein moving the supporting position comprises moving the supporting position to compensate for a change in the center of gravity.

3. The method of claim 2, wherein moving the supporting position comprises aligning the supporting position with the center of gravity.

4. The method of claim 1, wherein determining the center of gravity comprises retrieving center of gravity data from a data source associated with the imaging device.

5. The method of claim 4, wherein moving the supporting position comprises changing the supporting position according to the retrieved center of gravity data.

6. The method of claim 5, wherein changing the supporting position comprises shifting the supporting position along an optical axis of the imaging device.

7. The method of claim 5, further comprising determining whether a load applied by the imaging device is within a tolerance range.

8. The method of claim 7, wherein determining whether the load applied by the imaging device is within the tolerance range comprises comparing the load applied by the imaging device with a predetermined load threshold.

9. The method of claim 7, further comprising determining the load based upon the center of gravity and a mass of the imaging device.

10. The method of claim 9, wherein determining the load comprises calculating the load according to at least a focal length or a focus position of the imaging device.

11. The method of claim 7, wherein moving the supporting position comprises moving the supporting position in response to the load being determined to be outside of the tolerance range.

12. The method of claim 7, further comprising determining an adjustability of the supporting position.

13. The method of claim 12, wherein determining the adjustability comprises ascertaining a restriction of a supporting mechanism associated with the imaging device.

14. The method of claim 7, further comprising determining a desired movable position of the supporting position.

15. The method of claim 14, wherein determining the desired movable position comprises acquiring the desired movable position based upon at least commanded attitude or a predetermined load threshold.

16. The method of claim 15, wherein acquiring the desired movable position comprises:
equating the desired movable position to a maximum allowable supporting position in response to the load being greater than the predetermined load threshold; and
equating the desired movable position to the center of gravity in response to the load being less than or equal to the predetermined load threshold.

17. The method of claim 16, wherein equating the desired movable position to the maximum allowable position comprises determining the maximum allowable position at which the load of the imaging device is equal to the predetermined load threshold.

18. The method of claim 17, wherein moving the supporting position comprises shifting the supporting position to the desired movable position in response to the desired movable position being different from a current position of the supporting position and maintaining the supporting position in response to the desired movable position being equal to the current position.

19. The method of claim 18, wherein shifting the supporting position comprises operating a supporting mechanism of the imaging device to change the supporting position.

20. The method of claim 19, wherein operating the supporting mechanism comprises activating a gimbal associated with the imaging device.
